(19) United States
(12) Patent Application Publication
(10) Pub. No.: US 2018/0139220 A1
(43) Pub. Date: May 17, 2018

(54) SHARED CAPABILITY SYSTEM

(71) Applicant: BANK OF AMERICA CORPORATION, Charlotte, NC (US)

(72) Inventors: Mohana Viswanathan, Princeton, NJ (US); Dirk Edward Anderson, Jacksonville, FL (US); Mallikarjuna Reddy Jangamareddy, Piscataway, NJ (US); Sundar Krishnamoorthy, East Windsor, NJ (US); Vimalnath Umapathi, Robbinsville, NJ (US); Suresh Nair, Robbinsville, NJ (US)

(21) Appl. No.: 15/351,083

(22) Filed: Nov. 14, 2016

(51) Int. Cl. H04L 29/06; G06F 11/30; G06F 11/34

(52) U.S. Cl. CPC H04L 63/1425; G06F 11/3495; G06F 11/3476; G06F 11/3006

(57) ABSTRACT

Systems, computer products, and methods are described herein for a shared capability system for improved logging of events that occur on systems and within applications on the systems. The present invention captures logged data, converts it into a format that is uniform across multiple systems and applications, and streams the logged data to a centralized storage database for analysis and reporting, without ever storing the logged data on the applications and/or systems on which the events occurred. As such, the shared capability provides a consistent mechanism, with minimal costs, to enable event capture across multiple applications while improving the storage memory, speed, and capacity of the applications and/or systems on which the events occurred because logged data is not stored locally on the applications and/or systems.

### FIELD

The present invention relates to systems for capturing log data for events that occur on systems and within applications in order to improve the storage memory, speed, and capacity across the network of systems and applications.

### BACKGROUND

Logging of events for systems and applications typically occurs on the local systems and within the local application in which the events occur. This logging results in high costs associated with localized storage, memory, and capacity.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer products, and methods are described herein for an improved shared capability system for improved logging of events that occur on systems and within applications on the systems. Most systems and applications include log collection of events locally on the systems and within the applications on which the events occur. The local logging occurs through customized programing and the log storage occurs on the individual systems on which the applications reside. Additional customized applications are typically created into order to read the log files on each of the individual applications and systems. Current logging practices create issues with having enough storage, memory, and capacity to store the logged data and/or to access the logged data for meaningful analysis and reporting. The present invention provides systems, computer program products, and methods for capturing the logged data, converting it into a format that is uniform across multiple systems and applications, and streaming the logged data to a centralized storage database for analysis and reporting. As such, the shared capability provides a consistent mechanism, with minimal costs, to enable event capture across multiple applications. The shared capability enables different units within the organizations to meet instrumentation needs across an organization in a standard consistent manner, while enabling reporting capabilities from a centralized location within the organization.

Embodiments of the invention comprise systems, computer products, and methods for a shared capability system for providing increased memory, speed and capacity for a plurality of applications and a plurality of systems. The invention includes receiving streamed log data from events occurring on the plurality of applications and the plurality of systems without storing the log data in the plurality of applications and on the plurality of systems; batching and compressing the log data using a log aggregator; transmitting the log data to a central data storage; applying rules to the log data to identify potential security threats; send notifications for reporting the log data and the potential security threats when the potential security threats are identified; and wherein the shared capability system increases the memory, the speed and the capacity of the plurality of applications and the plurality of systems.

In further accord with embodiments of the invention receiving the streamed log data comprises identifying event information from the plurality of applications and the plurality of systems; and capturing the log data from the event information utilizing a standard appender across the plurality of applications and the plurality of systems.

In other embodiments, the invention further comprises validating the quality of the streamed log data before batching and compressing the log data into the transformed log data.

In yet other embodiments applying rules to the transformed log data comprises decompressing the log data from the central data storage; transmitting the decompressed log data to a queue; and applying pattern recognition, suspicious activity detection, or threshold rules to the log data from the queue.

In still other embodiments, sending notifications for reporting the log data and the potential security threats comprises streaming the log data into a database platform; accessing event information associated with the log data; supplementing the log data with event information; and reporting the log data or the potential security threats supplemented with the event information to users within the organization.

In further accord with embodiments, the invention further comprises sending the streamed log data and potential security threats supplemented with event information to long-term data storage and deep data analysis.

In other embodiments of the invention, the security of the organization is improved by monitoring the log data for the plurality of applications and the plurality of systems in real-time without having to access stored log data in the plurality of applications and on the plurality of systems from which the log data originates.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, and wherein:

FIG. 1 illustrates a block system diagram of a shared capability system environment, in accordance with embodiments of the invention.

FIG. 2 illustrates an end-to-end process shared capability flow, in accordance with embodiments of the invention.

FIG. 3 illustrates an application information log process flow, in accordance with embodiments of the invention.

FIG. 4 illustrates a data management flow for the logged information, in accordance with embodiments of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Systems, methods, and computer program products are herein disclosed that provide for improving the storage memory, speed, and capability across the network of systems and applications. The improvements are made at least in part on utilizing a standardized logging application for events that occurs on systems and applications, and streaming the log data for the events directly to centralized data storage, through which the organization can improve upon analyzing, monitoring, and reporting data regarding the systems and applications from the streamed log data. Moreover, the systems, methods, and computer program products provide improved security by allowing the organization to capture more information for events that occur on systems and applications and in a more time efficient process (e.g., in real-time, such as immediately, within seconds, or the like), which allows for a more thorough examination of log data to identify potentially compromised information.

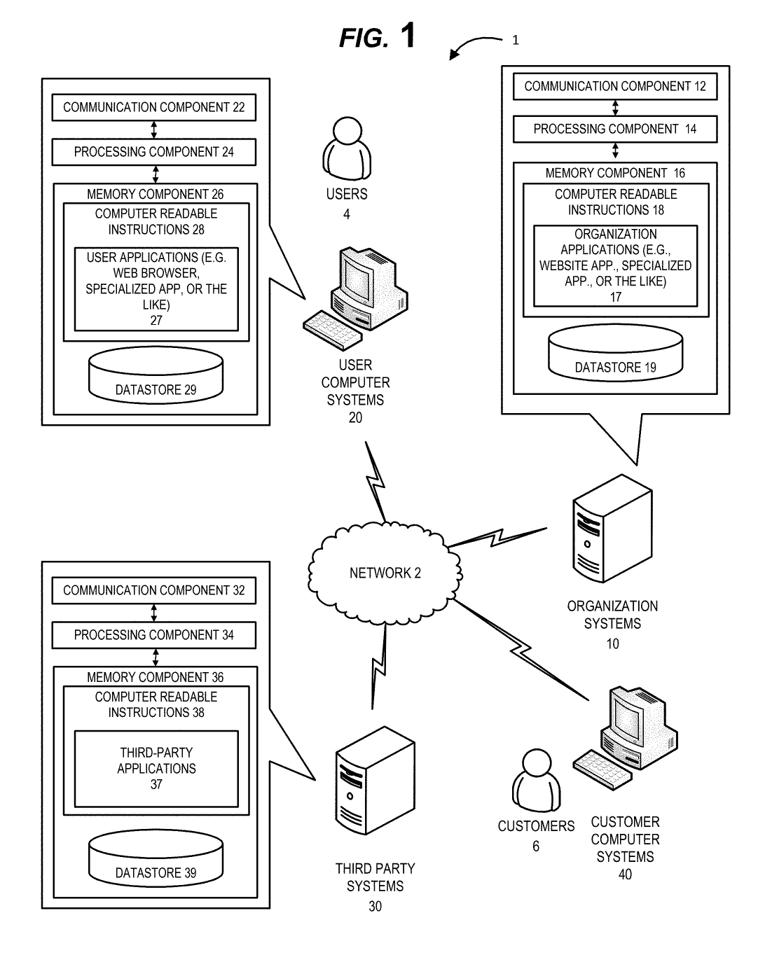

FIG. 1 illustrates a shared capability system environment 1, in accordance with embodiments of the invention. As illustrated in FIG. 1, one or more organization systems 10 are operatively coupled, via a network 2, to one or more user computer systems 20, one or more third-party systems 30, one or more customer computer systems 40, and/or one or more other systems (not illustrated). In this way, the logged data for events associated with the organization systems 10, the user customer systems 20, the third party systems 30, the customer computer systems 40, and/or the like, and the applications associated with each of the systems, may be streamed to storage in a central repository in a consistent format instead of locally saving the logged data on the systems within the applications on the systems through which the events occurs. As such, the systems and applications described herein may have more storage memory, may have greater speed (e.g., run faster), may have more capacity, and may be more network friendly because the logged data associated with events is not stored locally. Moreover, the centralized logged information may be utilized in order to analyze, monitor, and report potential compromises in the information that may be accessed by or created within the systems and applications, as will be described in further detail herein. The improvements of the shared capability system environment 1 over typically logging will be discussed in further detail herein.

The network 2 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 1, the organization systems 10 generally comprise one or more communication components 12, one or more processing components 14, and one or more memory components 16. The one or more processing components 14 are operatively coupled to the one or more communication components 12 and the one or more memory components 16. As used herein, the term “processing component” generally includes circuitry used for implementing the communication and/or logic functions of a particular system. For example, a processing component 14 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components 14 may include functionality to operate one or more software programs based on computer-readable instructions 18 thereof, which may be stored in the one or more memory components 16.

The one or more processing components 14 use the one or more communication components 12 to communicate with the network 2 and other components on the network 2, such as, but not limited to, the components of the user computer systems 20, the third party systems 30, the customer computer systems 40, and/or other systems. As such, the one or more communication components 12 generally comprise a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors and the like.

As further illustrated in FIG. 1, the organization systems 10 comprise computer-readable instructions 18 stored in the memory component 16, which in one embodiment includes the computer-readable instructions 18 of organization applications 17. In some embodiments, the one or more memory components 16 include one or more data stores 19 for storing data related to the organization systems 10, including, but not limited to, data created, accessed, and/or used by the organization application 17. It should be understood that that organization systems 10 and organization applications 17 are at least some of the systems and applications that are disclosed and discussed herein from which information related to events is logged (e.g., log data, or otherwise described as logged data) and/or which receives log data in order to analyze, monitor and report log data that may indicate compromised information in the systems and applications (e.g., information that may have been misappropriated by a user 4, improperly accessed, or the like).

As illustrated in FIG. 1, users 4 (e.g., associates, employees, agents, contractors, or the like associated with the organization) may access the organization applications 17, or other applications, through user computer systems 20. The user computer systems 20 may be a desktop, laptop, tablet, mobile device (e.g., smartphone device, or other mobile device), or any other type of computer that generally comprises one or more communication components 22, one or more processing components 24, and one or more memory components 26.

The one or more processing components 24 are operatively coupled to the one or more communication components 22, and the one or more memory components 26. The one or more processing components 24 use the one or more communication components 22 to communicate with the network 2 and other components on the network 2, such as, but not limited to, the organization systems 10, the third-party systems 30, the customer computer systems 40, and/or other systems. As such, the one or more communication components 22 generally comprise a wireless transceiver, modem, server, electrical connection, or other component for communicating with other components on the network 2. The one or more communication components 22 may further include an interface that accepts one or more network interface cards, ports for connection of network components, Universal Serial Bus (USB) connectors and the like. Moreover, the one or more communication components 22 may include a keypad, keyboard, touch-screen, touchpad, microphone, mouse, joystick, other pointer component, button, soft key, and/or other input/output component(s) for communicating with the users 4.

As illustrated in FIG. 1, the user computer systems 20 may have computer-readable instructions 28 stored in the one or more memory components 26, which in one embodiment includes the computer-readable instructions 28 for user applications 27, such as dedicated applications (e.g., apps, applet, or the like), portions of dedicated applications, a web browser or other apps that allow access to applications located on other systems, or the like.

As illustrated in FIG. 1, one or more third-party systems 30 may be accessed by the organization systems 10 and/or user computer systems 20 to access information that is used by the organization systems 17 and/or user applications 27. As such, the third-party systems 30 are operatively coupled, via a network 2, to the one or more organization systems 10, the user computer systems 20, the customer computer systems 40, and/or other systems. The third-party systems 30 generally comprise one or more communication components 32, one or more processing components 34, and one or more memory components 36.

The one or more processing components 34 are operatively coupled to the one or more communication components 32, and the one or more memory components 36. The one or more processing components 34 use the one or more communication components 32 to communicate with the network 2 and other components on the network 2, such as, but not limited to, the components of organization systems 10, the user computer systems 20, the customer computer systems 40, and/or other systems. As such, the one or more communication components 32 generally comprise a wireless transceiver, modem, server, electrical connection, or other component for communicating with other components on the network 2. The one or more communication components 32 may further include an interface that accepts one or more network interface cards, ports for connection of network components, Universal Serial Bus (USB) connectors and the like.

As illustrated in FIG. 1, the third-party systems 30 may have computer-readable instructions 38 stored in the one or more memory components 36, which in one embodiment includes the computer-readable instructions 38 of third-party applications 37 that allow the organization applications 17 and/or the user applications 27 to access information through the third-party applications 37.

Moreover, as illustrated in FIG. 1, the customer computer systems 40 and/or other like systems are operatively coupled to the organization systems 10, the user computer systems 20, and/or the third-party systems 30, through the network 2. The customer computer systems 40 and/or other like systems have components the same as or similar to the components described with respect to the organization systems 10, the user computer systems 20, and/or the third-party systems 30 (e.g., one or more communication components, one or more processing components, and one or more memory devices with computer-readable instructions of one or more applications, one or more datastores, or the like). Thus, the customer computer systems 40 and/or other like systems communicate with the organization systems 10, the user computer systems 20, the third-party systems 30, and/or each other in same or similar way as previously described with respect to the organization systems 10, the user computer systems 20, and/or the third-party systems 30. The customer computer systems 40 may be used by customer 6 to access the organization systems 10 in order to take actions with respect to the customer's accounts with the organization.

It should be understood that the organization applications 17 on the organization systems 10 and/or the user applications 2 on the user computer systems 10 may have access to confidential information, such as customer information (e.g., financial information, identifying information, purchasing information, marketing information, or any other type of customer information), organization information (e.g., financial information, product information, proprietary intellectual property information, design information, customer information, or any other types of organization information), and/or user information (e.g., employee information, identifying information, user access information, or any other type of user information). Depending on the types of applications and/or systems, information related to events may or may not be important to the administrators of the applications and/or systems may be typically logged by the applications and/or systems. As such, each application and/or system typically has its own process for logging the information locally within the applications and/or systems on which the applications are located or two which the applications write logged information. As such, this logging is performed on each user computer system 20, each organization system 10, and/or other systems by any number of different standard logging applications or specialized applications. The present invention may provide new systems, computer program products, and methods for logging data associated with events and using the logged data.

The events that may occur through the systems and/or applications may include organization compliance events, which may be logged for compliance, organization monitoring, and/or monitoring purposes. This type of logged data may require reliable delivery, longer retention periods, may be lower volume because it is specific, may require analysis to remove duplicative events, may include functional information, may require information hierarchy, may require independent channel collection, may require capturing for reporting, may include high priority information, and may include sensitive information and/or information associated with users that have accessed sensitive information. The organization compliance events may include information for compliance, audit services, legal, forensic investigation, business reporting, and/or the like. In other aspects of the invention, the events may be activity events, which may be logged by systems and/or applications for system and/or application management and/or reporting purposes. This type of activity event information may require reliable delivery, accurate information to allow for issue resolution or reporting, may be functional information, may be related to the systems and applications themselves and not the organization, may require separate channel collection for consistency, may require medium and/or short retention, may include medium volumes depending on the system and/or application outages, may allow duplicative events, may require hierarchal relationships, may require capture, and may have medium and/or low priority. This activity events may include information for system activity (e.g., operating systems, application performance, system performance, or the like), and/or application activity (e.g., run-time information, exceptions, warnings, or the like). As such, the compliance events and/or the activity events may require capturing, analysis, monitoring, and/or reporting in a way that is an improvement over local logging of the events.

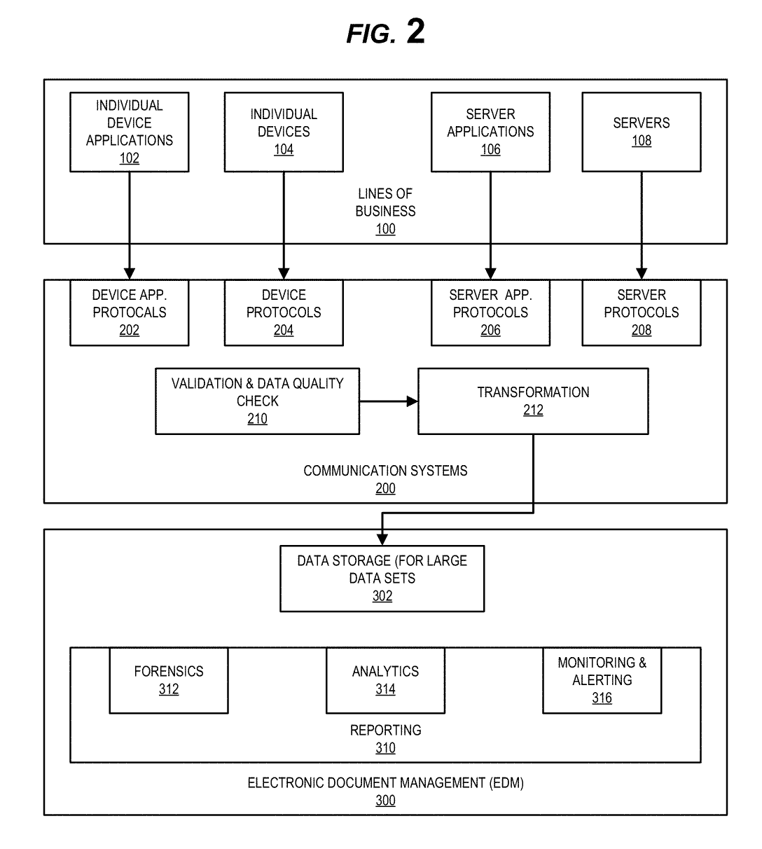

FIG. 2 illustrates an end-to-end process flow for a shared capability process, in which an organization may stream log data associated with events to a centralized location by capturing the log data, aggregating the log data, streaming the log data to the centralized location, applying rules to the log data to determine potential compromised information, supplementing the log data and/or potential compromised information with identifying information (e.g., user data from human resources, application and/or system data from information systems data, or the like), and transmitting the log data and/or the potential security threats with the identifying information for notifications (e.g., analyzing, monitoring, and/or reporting the log data) or for long term storage and/or deep data analysis.

As illustrated by block 100 in FIG. 2, within an organization there may be sub-groups (e.g., lines of business, or the like) that utilize the same or different systems (e.g., devices, servers, or the like) and applications. For example, as illustrated in FIG. 2, there may be individual device applications 102 (e.g., browser applications, mobile device applications, specialized apps or portions thereof, or the like) associated with individual devices 104 (e.g., user computer systems 20 as described with respect to FIG. 1, or the like), servers applications 106 and associated servers (e.g., supporting multiple devices, server applications, or the like), or other like systems and applications not specifically described herein. For large institutions, there may be hundreds of thousands of devices that use thousands of applications across the organization, which my result in hundreds of millions of events that occur on the systems and applications in just one day. Each event may have a plurality of event information that is captured for logging. This may result in billions of individual portions of event information that is logged as log data. Moreover, each of the systems and applications may utilize different logging applications to log data captured from the event information. Typically, log data is stored locally on the systems and/or through the applications through which the event occurred. In this way, each system and application may have to direct significant resources to capturing and storing the event information as log data. This capturing and storing of the log data reduces the memory, speed, and capacity of the plurality of applications and plurality of systems.

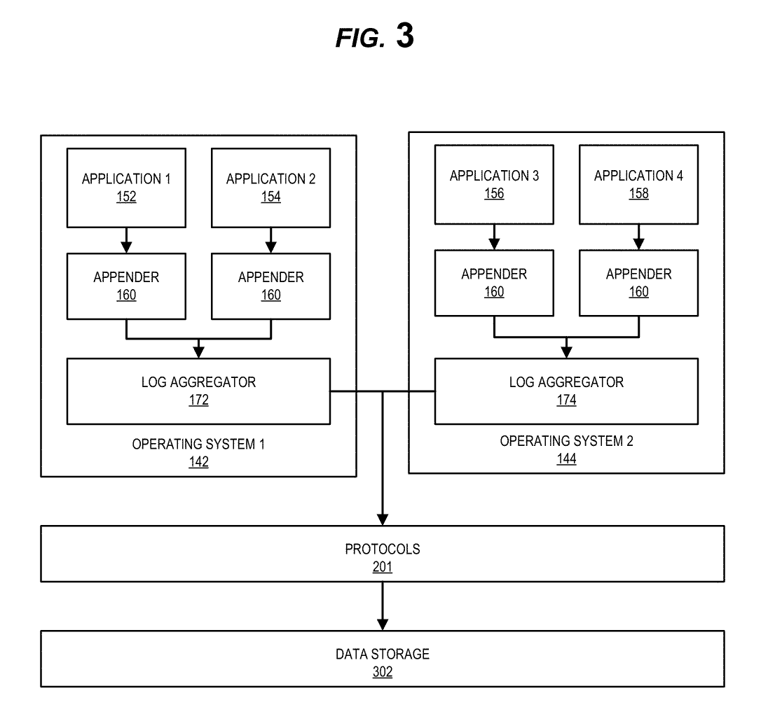

Unlike typical systems, the present invention utilizes a single appender type across the plurality of systems and the plurality of applications, as is illustrated in one example in FIG. 3. FIG. 3 illustrates an application information log process flow, regarding how data is captured from various applications. As such, as illustrated in the example in FIG. 3, there may be multiple operating systems 140 (e.g., operating system 1 142, operating system 2 144, or the like). Each of the operating systems 140 may support different applications 150 (e.g., application 1 152, application 2 154, application 3 156, application 4, 158, or the like). However, each of the applications utilize the same type of appender 160. The same appender 160 may be an appender that logs data in the same way for each application 150 on each operating systems 140. As such, the appenders 160 may be the same appender, or may be different appenders that log data in the same way. The uniform appender type described herein with respect to the applications in FIG. 3, may also be utilized for each system described herein (e.g., individual devices, servers, or the like).

As further illustrated in FIG. 3 a log aggregator 170 may be utilized for batching and compressing the data logged by the appenders 160 (e.g., for both applications 150 and systems). The log aggregators 170 may be the same log aggregators 170, but may also be different aggregators depending on the operating systems (e.g., log aggregator 1 172, log aggregators 174, or the like) and the endpoints through which the log data is transmitted. As such, the batching and compressing of the log data allows the log data to be sent to endpoints and to comply with protocols 201 and eventually data storage 302, as will be discussed with respect to FIG. 2.

It should be understood that the log data related to the event information from the events may be transmitted by being pushed or pulled as individual log data and/or as bulk log data. Moreover, depending on the applications and systems, custom classes for the applications and/or systems may be utilized for formatting the log data captured from the event information. That is, like log data (e.g., similar log data such, access to or actions taken with an application on a system) may be batched and/or compressed for improved storage, analysis, and use.

Returning to FIG. 2, as illustrated by the communication systems of block 200, the protocols (e.g., individual device protocol 202, device protocol 204, server application protocol 206, server protocols 208, and/or the like) are utilized to govern the exchange and/or transmission of the log data from the systems and applications. The protocols for the endpoints allow the log data to be stored in single layer for further processing. As such, the log data may be filtered through a validation and data quality check, as illustrated in block 210, to determine if the log data captured, aggregated, and compressed is correct, and no issues are identified in the data. As further illustrated in FIG. 2, the log data may be transformed into useable data that can be indexed, analyzed, visualized, or otherwise transformed into usable data (e.g. transformed log data, or the like). This process may occur through ETL (Extract, Transform, Load) processes in order to store the log data in the proper format for additional processing (e.g., searching, analysis, reporting, or the like). The transformed logged data may thereafter be transmitted (e.g., pushed, pulled, or the like) to an electronic documents management (EDM) system 300. As such, the transformed log data may be stored in a single data storage environment 302. The data storage environment 302 is able to store large sets of data in a single format and location, such that the transformed logged data may be utilize for providing notifications, such as analyzing, monitoring, and reporting the log data as needed. As illustrated by the reporting block 310, the logged data may be processed using forensics 312, analytics 314, monitoring and alerting 316, or the like.

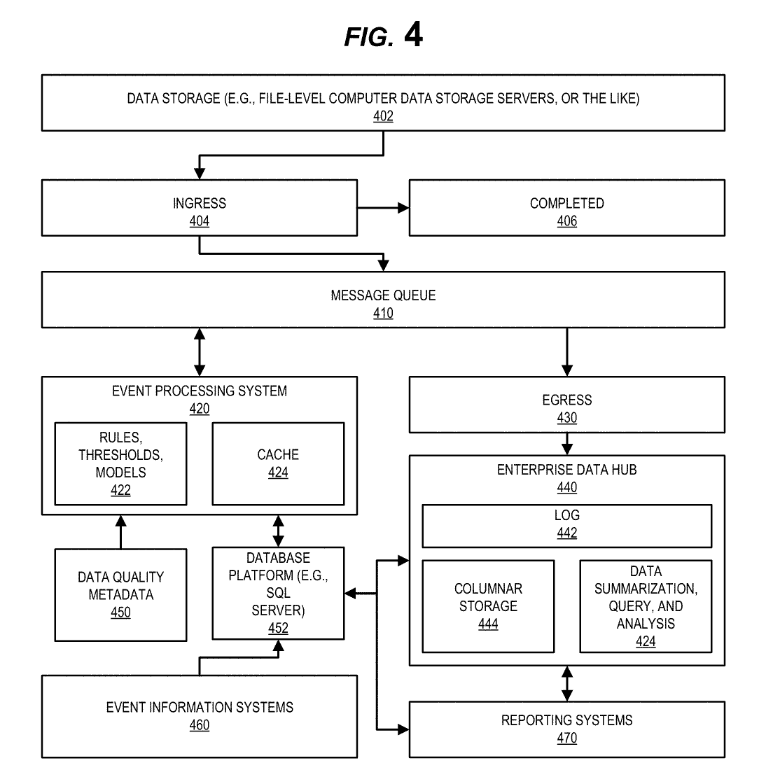

The data storage and reporting process flow for the transformed log data illustrated in block 300 in FIG. 2, is illustrated and described in further detail in one example in FIG. 4. As illustrated in FIG. 4, the data storage block 402 illustrates that the transformed log data is stored as large data sets in the data storage (e.g., file-level computer data storage, or the like). The log data is streamed for processing from the data storage for ingress into an event processing system, as illustrated in block 404. The log data is read and decompressed for processing in block 404. Log data that is completed is stored in a completed file, as illustrated by block 406. The streamed log data may be held in a message queue for additional processing, as illustrated in block 410.

The message queue may communicate with the event processing system 420, in which rules (e.g., thresholds, models, or the like) are applied to the log data to identify patterns (e.g., pattern recognition), suspicious activity information (e.g., suspicious activity detection), or the like in order to determine if the log data identifies potentially compromised event information. The event processing system 420 may include a rules engine (e.g., thresholds, modeling, or the like) through which the rules are applied to the log data, as illustrated in block 422. Moreover, the log data and/or the log data run through the rules engine may be stored in a cache database for future use, as illustrated by block 424. Metadata, as illustrated in block 450 in FIG. 4, may be utilized to check the log data and/or for analysis to determine quality, validity, and/or completeness of the log data. The log data that is run through the rules engine is then streamed to a database platform server, such as a SQL server, as illustrated in block 452 for near-real-time reporting, as will be discussed in further detail later.

It should be further understood that the log data streamed into the database platform 452 may be supplemented with additional event information (e.g., such as human resources information) from event information systems, as illustrated by block 460. For example, the event information related to users accessing an application or using a device, may be enhanced with information regarding the user that that did the accessing, the time of the event, or the like. Moreover, application names and/or access information may be included in the log data before it is sent for reporting and/or to storage and/or deep analysis in the enterprise data hub.

The analyzed log data is also passed back through the event processing systems 420, to the message queue 410, and to egress, as illustrated in block 430, for transmission to the enterprise data hub 440. As such, the log data and associated analysis thereof may be serialized for reading without knowing the associated schema, the log data and associated analysis may also be compressed for memory, speed, and capacity improvements (e.g., increased memory, speed, and capacity). Moreover, the log data and associated analysis may also be stored for long term storage in instrumentation logs, as illustrated by block 442, columnar storage, as illustrated in block 444, and/or data summarization and analysis storage, as illustrated in block 424.

As illustrated by the reporting system block 470, the log data that is streamed from the database platform may be reported to a particular user within the organization if it triggers a notification after the rules are applied to the log data. The reporting may occur based directly on the information that is streamed in real-time and/or near-real time from the applications and/or systems, as discussed above. However, in other aspects of the invention the log data that is streamed may also be compared to the log data stored in the long-term storage for patterns and/or for suspicious activity when the real-time data is analyzed along with the long-term log data.

Since the log data is streamed in real-time the reporting systems 470 allow the organization to provide notifications in real-time to users 4 within the organization. As such, notifications of events occurring across the various applications and systems may be sent to a case management systems that is used to monitor the applications and/or systems within the organization that stores and/or has access to sensitive information. The case managements system may provide notifications, in the form of automated e-mails, escalation alerts, time sensitive alerts, action alerts for automatically taking actions with respect to the applications and/or systems (e.g., locking them, or the like), or the like.

For example, the streamed log data allows the organization to identify immediately when applications and systems that have sensitive data are being accessed, the identity of the users 4 accessing the applications and systems, and the actions the users 4 are taking within the applications and systems. The real-time analysis of the log data allows the event processing system 420 to analyze these applications and systems, the users 4, and the actions taken by the users against patterns, and cross-reference the applications and systems, the users 4, and the actions for within an organization in order to determine if the applications and systems, or the information therein may be compromised. For example, if a user 4 is accessing an application at an unusual time and/or is taking an action within the application that is not typical of the user 4, the analysis system may send a notification to a supervisor or another user 4 in the organization to investigate the action in more detail. Moreover, the organization systems may be able to automatically lock the application and/or the user's ability to take actions within the application until the event can be investigated further. Without streaming the log data, the organization may be able to monitor the application directly, but the organizations cannot monitor the application and compare it with the events occurring on other applications and/or systems in real-time because of the inability to read log data in real time from different applications and systems. For example, a user 4 accessing an application may not be unusual, unless it can be compared with log data related to the user 4 taking actions within another applications at the same or similar time.

As previously described herein, by streaming the log data to centralized data storage, instead of storing the log data locally on the plurality of systems and within the plurality of applications, the memory, speed, and capacity of the systems and applications is improved because management of millions or billions of individual log data associated with the hundreds or thousands of applications and/or systems is storage managed centrally. As such, the shared capability enables the organization to meet the needs of each line of business in a standard and consistent manner, while enabling more accurate reporting capabilities because the log data is located in the central data storage in the same format. Moreover, costs associated with having to pay for applications to store the log data locally and/or to pay for applications to read the locally stored log data is saved because these types of applications are not needed. Finally, with all of the log data located in the same location, including the real-time streamed log data, and the long term log data in storage, all of the information needed for analysis and reporting is in one location (i.e., do not have to access the application and systems from which the log data originates). Without steaming all of the log data to centralized in real-time, some log data from the various applications and/or systems cannot be accessed and/or is missing because the applications and systems used for analyzing the log data may not have the ability to access the log data on various systems and/or applications that log data in different ways.

It should be understood, that the systems described herein may be configured to establish a communication link (e.g., electronic link, or the like) with each other in order to accomplish the steps of the processes described herein. The link may be an internal link within the same entity (e.g., within the same financial institution) or a link with the other entity systems. In some embodiments, the one or more systems may be configured for selectively monitoring the resource usage and availability. These feeds of resource usage and availability may be provided via wireless network path portions through the Internet. When the systems are not providing data, transforming data, transmitting the data, and/or creating the reports, the systems need not be transmitting data over the Internet, although it could be. The systems and associated data for each of the systems may be made continuously available, however, continuously available does not necessarily mean that the systems actually continuously generate data, but that a systems are continuously available to perform actions associated with the systems in real-time (i.e., within a few seconds, or the like) of receiving a request for it. In any case, the systems are continuously available to perform actions with respect to the data, in some cases in digitized data in Internet Protocol (IP) packet format. In response to continuously monitoring the real-time data feeds from the various systems, the systems may be configured to update activities associated with the systems, as described herein.

Moreover, it should be understood that the process flows described herein include transforming the data from the different systems (e.g., internally or externally) from the data format of the various systems to a data format associated with the reports for display. There are many ways in which data is converted within the computer environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may converting to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

As will be appreciated by one of skill in the art in view of this disclosure, embodiments of the invention may be embodied as an apparatus (e.g., a system, computer program product, and/or other device), a method, or a combination of the foregoing. Accordingly, embodiments of the invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the invention may be written in an object oriented, scripted or unscripted programming language such as Java, Pearl, Python, Smalltalk, C++ or the like. However, the computer program code/computer-readable instructions for carrying out operations of the invention may also be written in conventional procedural programming languages, such as the “C” programming language or similar programming languages.

Embodiments of the invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A shared capability system for providing increased memory, speed and capacity for a plurality of applications and a plurality of systems, the shared capability system comprising:
one or more memory devices having computer readable code store thereon; and
one or more processing devices operatively coupled to the one or more memory devices, wherein the one or more processing devices are configured to execute the computer readable code to:
receive streamed log data from events occurring on the plurality of applications and the plurality of systems without storing the log data in the plurality of applications and on the plurality of systems;
batch and compress the log data using a log aggregator;
transmit the log data to a central data storage;
apply rules to the log data to identify potential security threats;
send notifications for reporting the log data and the potential security threats when the potential security threats are identified; and
wherein the shared capability system increases the memory, the speed and the capacity of the plurality of applications and the plurality of systems.

2. The shared capability system of claim 1, wherein receiving the streamed log data comprises:
identifying event information from the plurality of applications and the plurality of systems; and
capturing the log data from the event information utilizing a standard appender across the plurality of applications and the plurality of systems.

3. The shared capability system of claim 1, wherein the one or more processing devices are configured to execute the computer readable code to:
validate the quality of the streamed log data before batching and compressing the log data into the transformed log data.

4. The shared capability system of claim 1, wherein applying rules to the transformed log data comprises:
decompressing the log data from the central data storage;
transmitting the decompressed log data to a queue; and
applying pattern recognition, suspicious activity detection, or threshold rules to the log data from the queue.

5. The shared capability system of claim 1, wherein sending notifications for reporting the log data and the potential security threats comprises:
streaming the log data into a database platform;
accessing event information associated with the log data;
supplementing the log data with event information; and
reporting the log data or the potential security threats supplemented with the event information to users within the organization.

6. The shared capacity system of claim 5, wherein one or more processing devices are configured to execute the computer readable code to:
send the streamed log data and potential security threats supplemented with event information to long-term data storage and deep data analysis.

7. The shared capability system of claim 1, wherein security of the organization is improved by monitoring the log data for the plurality of applications and the plurality of systems in real-time without having to access stored log data in the plurality of applications and on the plurality of systems from which the log data originates.

8. A computer implemented method for a shared capability system for providing increased memory, speed and capacity for a plurality of applications and a plurality of systems, the method comprising:
receiving, by one or more processing devices, streamed log data from events occurring on the plurality of applications and the plurality of systems without storing the log data in the plurality of applications and on the plurality of systems;
batching and compressing, by the one or more processing devices, the log data using a log aggregator;
transmitting, by the one or more processing devices, the log data to a central data storage;
applying, by the one or more processing devices, rules to the log data to identify potential security threats;
sending, by the one or more processing devices, notifications for reporting the log data and the potential security threats when the potential security threats are identified; and
wherein the shared capability system increases the memory, the speed and the capacity of the plurality of applications and the plurality of systems.

9. The computer implemented method of claim 8, wherein receiving the streamed log data comprises:
identifying event information from the plurality of applications and the plurality of systems; and
capturing the log data from the event information utilizing a standard appender across the plurality of applications and the plurality of systems.

10. The computer implemented method of claim 8, further comprising:
validating, by the one or more processing devices, the quality of the streamed log data before batching and compressing the log data into the transformed log data.

11. The computer implemented method of claim 8, wherein applying rules to the transformed log data comprises:
decompressing the log data from the central data storage;
transmitting the decompressed log data to a queue; and
applying pattern recognition, suspicious activity detection, or threshold rules to the log data from the queue.

12. The computer implemented method of claim 8, wherein sending notifications for reporting the log data and the potential security threats comprises:
streaming the log data into a database platform;
accessing event information associated with the log data;
supplementing the log data with event information; and
reporting the log data or the potential security threats supplemented with the event information to users within the organization.

13. The computer implemented method of claim 12, further comprising:
sending the streamed log data and potential security threats supplemented with event information to long-term data storage and deep data analysis.

14. The computer implemented method of claim 8, wherein security of the organization is improved by monitoring the log data for the plurality of applications and the plurality of systems in real-time without having to access stored log data in the plurality of applications and on the plurality of systems from which the log data originates.

15. A computer program product for a shared capability system for providing increased memory, speed and capacity for a plurality of applications and a plurality of systems, the computer program product comprising at least one non-transitory computer-readable medium having computer-readable program code portions embodied therein, the computer-readable program code portions comprising:
an executable portion configured to receive streamed log data from events occurring on the plurality of applications and the plurality of systems without storing the log data in the plurality of applications and on the plurality of systems;
an executable portion configured to batch and compress the log data using a log aggregator;
an executable portion configured to transmit the log data to a central data storage;
an executable portion configured to apply rules to the log data to identify potential security threats;
an executable portion configured to send notifications for reporting the log data and the potential security threats when the potential security threats are identified; and
wherein the shared capability system increases the memory, the speed and the capacity of the plurality of applications and the plurality of systems.

16. The computer program product of claim 15, wherein the executable portion configured to receive the streamed log data comprises:
an executable portion configured to identify event information from the plurality of applications and the plurality of systems; and
an executable portion configured to capture the log data from the event information utilizing a standard appender across the plurality of applications and the plurality of systems.

17. The computer program product of claim 15, further comprising:
an executable portion configured to validate the quality of the streamed log data before batching and compressing the log data into the transformed log data.

18. The computer program product of claim 15, further comprising:
an executable portion configured to decompress the log data from the central data storage;
an executable portion configured to transmit the decompressed log data to a queue; and
an executable portion configured to apply pattern recognition, suspicious activity detection, or threshold rules to the log data from the queue.

19. The computer program product of claim 15, wherein the executable portion configured to send notifications for reporting the log data and the potential security threats comprises:
an executable portion configured to stream the log data into a database platform;
an executable portion configured to access event information associated with the log data;
an executable portion configured to supplement the log data with event information; and
an executable portion configured to report the log data or the potential security threats supplemented with the event information to users within the organization.

20. The computer program product of claim 19, further comprising:
an executable portion configured to send the streamed log data and potential security threats supplemented with event information to long-term data storage and deep data analysis.
